(19) United States
(12) Patent Application Publication
(10) Pub. No.: US 2023/0171351 A1
(43) Pub. Date: Jun. 1, 2023

(54) IMAGE FORMING APPARATUS

(71) Applicant: KYOCERA Document Solutions Inc., Osaka (JP)

(72) Inventor: Ryuichi NITTA, Osaka-shi (JP)

(73) Assignee: KYOCERA Document Solutions Inc., Osaka (JP)

(21) Appl. No.: 17/680,610

(22) Filed: Feb. 25, 2022

(30) Foreign Application Priority Data
Feb. 26, 2021 (JP) 2021-030313

(51) Int. Cl. H04N 1/00

(52) U.S. Cl. CPC H04N 1/00411; H04N 2201/0094

(57) ABSTRACT

An image forming apparatus includes an image forming section, an operation section, and a controller. The image forming section forms an image on a recording medium. The operation section includes a touch panel. The controller controls the image forming section and the operation section. The controller acts to display a screen that presents predetermined items on the touch panel, start operation guidance by the operation section, start display whose gradation changes in a predetermined guidance direction, and wait for swipe operation by an operator with reception prohibited by displaying, in grayscale, unrelated icons among icons of the predetermined items.

### INCORPORATION BY REFERENCE

The present application claims priority under 35 U.S.C. § 119 to Japanese Patent Application No. 2021-030313, filed on Feb. 26, 2021. The contents of this application are incorporated herein by reference in their entirety.

### BACKGROUND

The present disclosure relates to an image forming apparatus.

An information processing apparatus displays a plurality of items on a screen and displays a spotlight-shaped image superimposed on a specific item with a high possibility of an operator selecting, thereby prompting the operator to select the specific item.

### SUMMARY

The image forming apparatus according to an aspect of the present disclosure includes an image forming section, an operation section, and a controller. The image forming section forms an image on a recording medium. The operation section includes a touch panel. The controller controls the image forming section and the operation section. The controller acts to display a screen that presents predetermined items on the touch panel, start operation guidance by the operation section, start display whose gradation changes in a predetermined guidance direction, and wait for swipe operation by an operator with reception prohibited by displaying, in grayscale, unrelated icons among icons of the predetermined items.

### BRIEF DESCRIPTION OF THE DRAWINGS

FIG. 1 is a schematic view illustrating an example of the structure of an image forming apparatus according to an embodiment.

FIG. 2 is a block diagram illustrating an example of a circuit configuration of the image forming apparatus.

FIG. 3 is a flowchart illustrating an example of the operation of a controller.

### DETAILED DESCRIPTION

An embodiment according to the present disclosure will be described with reference to the drawings. Elements that are the same or equivalent are labelled with the same reference signs in the drawings and description thereof is not repeated.

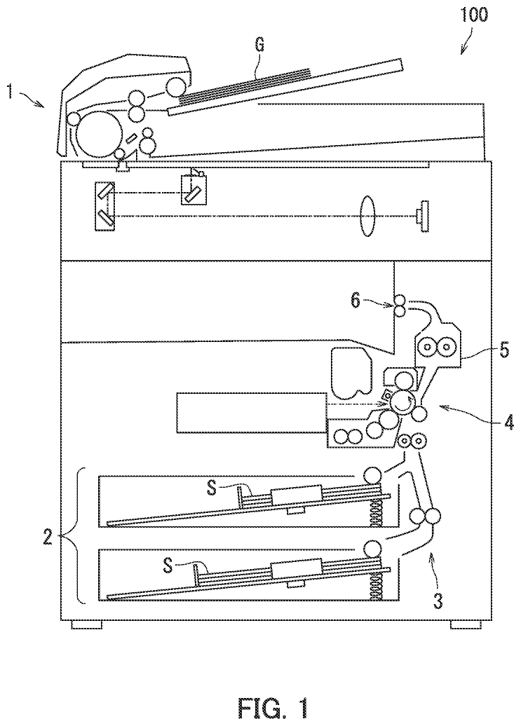

An image forming apparatus 100 according to an embodiment will be described with reference to FIG. 1. FIG. 1 is a schematic view illustrating an example of the configuration of the image forming apparatus 100. Examples of the image forming apparatus 100 include a photocopier, a printer, a facsimile, and a multifunction peripheral including these functions. In the embodiment described below, the image forming apparatus 100 is a monochrome multifunction peripheral.

As illustrated in FIG. 1, the image forming apparatus 100 includes a reading section 1, a feeding section 2, a conveyance section 3, an image forming section 4, a fixing section 5, and an ejection section 6.

The reading section 1 reads an image of a document G. The reading section 1 generates image data from the read image. The feeding section 2 accommodates a plurality of sheets S and feeds a sheet S to the conveyance section 3. The sheet S is made of, for example, paper or synthetic resin. The conveyance section 3 includes a plurality of conveyance roller pairs and conveys the sheet S to the image forming section 4. The sheet S corresponds to an example of a “recording medium”.

The image forming section 4 forms a toner image on the sheet S by an electrophotographic method. The image forming section 4 includes a photoconductor drum, a charger, an exposure device, a development device, a replenishment device, a transfer device, a cleaner, and a static eliminator. The toner image corresponds to, for example an image of the document G. The fixing section 5 applies heat and pressure to the toner image to fix the toner image on the sheet S. The conveyance section 3 conveys the sheet S on which the toner image is fixed to the ejection section 6. The ejection section 6 ejects the sheet S outside the image forming apparatus 100.

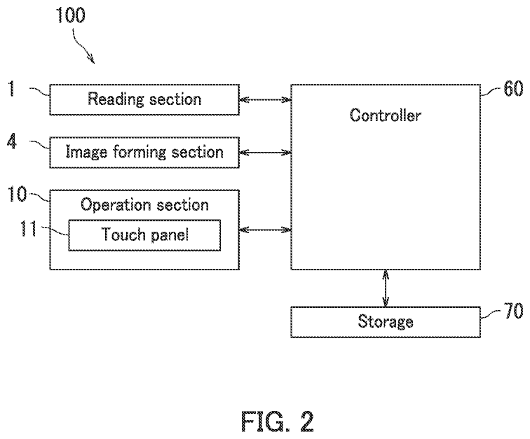

Next, a circuit configuration of the image forming apparatus 100 will be described with reference to FIGS. 1 and 2. FIG. 2 is a block diagram illustrating an example of the circuit configuration of the image forming apparatus 100.

As illustrated in FIG. 2, the image forming apparatus 100 further includes an operation section 10, a controller 60, and storage 70.

The operation section 10 is an input device for various user operations. The operation section 10 includes a touch panel 11. The operation section 10 may further include operation buttons. Information indicating the user operations are supplied to the controller 60.

The storage 70 includes a storage device and stores data and a computer program. The storage 70 includes a main storage device such as a semiconductor memory and an auxiliary storage device such as a hard disk drive.

The controller 60 includes a processor such as a central processing unit (CPU), and executes the computer program stored in the storage 70, thereby controlling each component of the image forming apparatus 100.

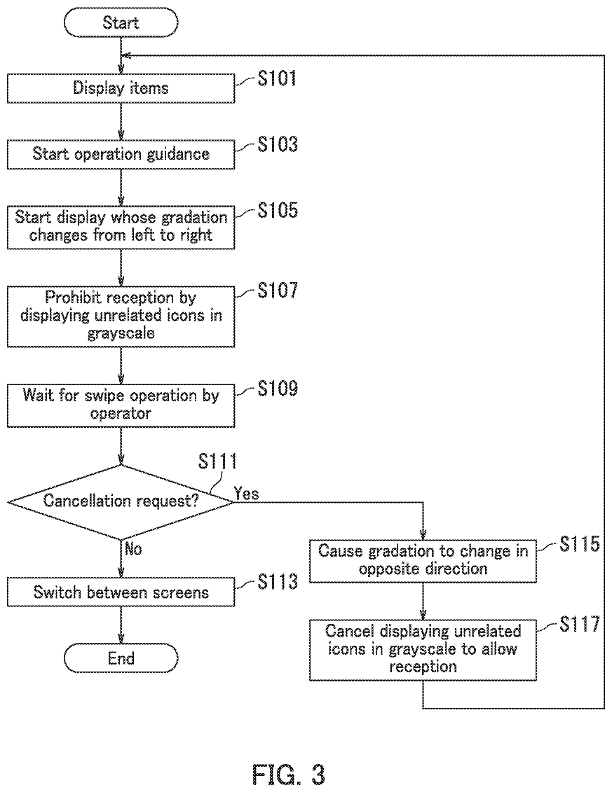

Next, the operation of the controller 60 will be described with reference to FIGS. 1 to 3. FIG. 3 is a flowchart illustrating an example of the operation of the controller 60.

Step S101: as illustrated in FIG. 3, the controller 60 displays, on the touch panel 11, a screen that presents a plurality of predetermined items. The action of Step S101 is completed, and then the process of the controller 60 proceeds to Step S103.

Step S103: the controller 60 starts operation guidance by the operation section 10. The action of Step S103 is completed, and then the process of the controller 60 proceeds to Step S105.

Step S105: the controller 60 starts display whose gradation changes in a predetermined guidance direction (from left to right). For example, the controller 60 displays the background color of the touch panel 11 in gradation and displays an animation, thereby repeating changing the color from a light color to a dark color in order. Thus, the controller 60 guides the transition to another item displayed on the next page of the touch panel 11. The action of Step S105 is completed, and then the process of the controller 60 proceeds to Step S107.

Step S107: the controller 60 prohibits reception by displaying, in grayscale, unrelated icons among icons of the items displayed on the touch panel 11. In other words, the controller 60 prevents an operation error by displaying, in grayscale, the icons that are not related to guiding the operator to the target screen so that the unrelated icons cannot be pressed. The action of Step S107 is completed, and then the process of the controller 60 proceeds to Step S109.

Step S109: the controller 60 waits for swipe operation by the operator. The action of Step S109 is completed, and then the process of the controller 60 proceeds to Step S111.

Step S111: the controller 60 determines whether or not the swipe operation indicates a cancellation request. When the swipe operation indicates the cancellation request (Yes in Step S111), the process of the controller 60 proceeds to Step S115. When the swipe operation does not indicate the cancellation request (No in Step S111), the process of the controller 60 proceeds to Step S113.

Step S113: the controller 60 acts to switch between screens of the touch panel 11 according to the operation guidance. The action of Step S113 is completed, and then the process of the controller 60 ends.

Step S115: the controller 60 recognizes that the operator did not follow the guidance, and then gives indication by causing the gradation to change in the direction (from right to left) opposite to the guidance direction in Step S105 for a certain period of time in the screen before the transition. The action of Step S115 is completed, and then the process of the controller 60 proceeds to Step S117.

Step S117: the controller 60 acts to stop the operation guidance and restore the icon displayed in grayscale to allow reception. The action of Step S117 is completed, and then the process of the controller 60 returns to Step S101.

The image forming apparatus 100 provided according to the embodiment can realize a powerful operation assist for an operator who is unfamiliar with the operation.

The image forming apparatus 100 according to the embodiment especially expresses the acceptance of the cancellation request in an easy-to-understand manner when the operator desires to cancel the guided operation without following the guidance, thereby realizing the powerful operation assist for the operator who is unfamiliar with the operation.

The embodiment of the present disclosure has been described above with reference to the drawings. However, the present disclosure is not limited to the above-described embodiment, and may be implemented in various aspects without departing from the gist thereof. In addition, various aspects may be created by appropriately combining the plurality of components disclosed in the above-described embodiment. For example, some components of all the components illustrated in the embodiment may be removed. The drawings schematically illustrate each component as a main body in order to make it easier to understand. The number and the like of illustrated components may differ from the actual ones for the convenience of the drawing. Further, each component illustrated in the above embodiment is an example and not particularly limited, and various modifications may be made without substantially deviating from the effects of the present disclosure.

In the embodiment, the image forming apparatus 100 employs the electrophotographic method. However, the present disclosure is not limited to this. For example, the image forming apparatus 100 may employ an inkjet method.

What is claimed is:

1. An image forming apparatus comprising:
an image forming section that forms an image on a recording medium;
an operation section that includes a touch panel; and
a controller that controls the image forming section and the operation section, wherein
the controller acts to display a screen that presents predetermined items on the touch panel, start operation guidance by the operation section, start display whose gradation changes in a predetermined guidance direction, and wait for swipe operation by an operator with reception prohibited by displaying, in grayscale, unrelated icons among icons of the predetermined items.

2. The image forming apparatus according to claim 1, wherein when the swipe operation does not indicate a cancellation request, the controller acts to switch between screens on the touch panel according to the operation guidance.

3. The image forming apparatus according to claim 1, wherein when the swipe operation indicates a cancellation request, the controller acts to perform display whose gradation changes in a direction opposite to the guidance direction and allow the reception with the displaying in grayscale canceled.
